(19) United States
(12) Patent Application Publication
(10) Pub. No.: US 2025/0335273 A1
(43) Pub. Date: Oct. 30, 2025

(54) AUTOMATIC CONFIGURATION AND DEPLOYMENT OF API FUNCTIONALITY IN A DISTRIBUTED COMPUTING ENVIRONMENT

(71) Applicant: FMR LLC, Boston, MA (US)

(72) Inventors: Basavaraja Sugeerappa, Hopkinton, MA (US); Vinodh Dhananjayan, Holly Springs, NC (US); Madhavan Narayanasamy, Morrisville, NC (US); Maxwell Morhardt, Boston, MA (US)

(21) Appl. No.: 18/646,684

(22) Filed: Apr. 25, 2024

(51) Int. Cl. G06F 9/54; G06F 8/65

(52) U.S. Cl. CPC G06F 9/547; G06F 8/65

(57) ABSTRACT

Methods and apparatuses for automatic configuration and deployment of API functionality in a distributed computing environment include creating an API description defining functional features of the API and validating the API description based upon technical constraints and compliance constraints. Source code files are generated based upon the API description, and updates to the source code files are received and applied. Resources used for deployment of the API are configured in the distributed computing environment. An API build is generated based upon the updated source code. The API build is deployed and published in the distributed computing environment to enable external computing resources to access the deployed API build in the distributed computing environment.

### TECHNICAL FIELD

This application relates generally to methods and apparatuses, including computer program products, for automatic configuration and deployment of application programming interface (API) functionality in a distributed computing environment.

### BACKGROUND

Most medium and large enterprise computing environments rely on a wide variety of application programming interfaces (APIs) to enable disparate computing systems to communicate with each other for the purposes of enabling robust software applications and functionality. In such computing environments, there is a need for development, deployment, and integration of many different APIs across various resources and teams.

However, the process of building and deploying APIs into a production environment for use by external requestors can take a significant amount of time-typically on the order of weeks or months. This includes an allotment of time for thorough testing and validation of the API functionality to ensure that the API is working correctly and complies with applicable enterprise standards and technical constraints. The exhaustive process for API creation, testing, and rollout to production means that improvements to application functionality are slow to reach external users and materially impacts the availability of development resources to work on other enhancements. Because application deployment involves many manual steps and different tools in current process, users who need to deploy applications needs to learn each tool (sometimes six to eight of them), get access to each tool, and already have know-how of the process and commands to use. All of these aspects are complex, and usually take a long time and much effort to learn. In addition, existing application deployment processes are not scalable and can be error prone due to the number of steps involved-one simple mis-click or typo can cause the process to start all over again.

### SUMMARY

Therefore, what is needed are methods and systems for configuration and deployment of APIs and related metadata in a production computing environment using a defined automation pipeline-thereby eliminating the effort associated with developer building, testing, and deployment of API resources. The techniques described herein advantageously generate API definitions and corresponding source code files, while also validating the definitions and source code to confirm compliance with technical objectives and enterprise standards. The techniques also automate the process of deploying newly-created APIs to production by allocating necessary computing resources in the production environment and exposing the APIs to external traffic automatically. All of the steps in the process described herein can be accomplished by a user with limited technical expertise via a specialized front-end user interface that enables creation and deployment of APIs with just a few clicks. The systems and methods described herein provide a one-stop shop with an easy-to-use user interface to handle all backend integrations, and forces the user to follow standards and be compliant. Also, the systems and methods create efficient APIs with a robust design and the ability to deliver the product in less time (i.e., reducing time to market). The techniques enable a no-code way of creating an API by removing all bottlenecks, while adhering to best practices and enabling shipment of new APIs and features faster. Unlike existing systems, the user do not need to have knowledge of each component which eliminates the learning curve and access to each tool/component.

The invention, in one aspect, features a system for automatic configuration and deployment of application programming interface (API) functionality in a distributed computing environment. The system comprises a server computing device having a memory for storing computer-executable instructions and a processor that executes the computer executable instructions. The server computing device creates an API description for an API to be deployed to the distributed computing environment, the description defining one or more functional features of the API. The server computing device validates the API description based upon one or more technical constraints and one or more compliance constraints. The server computing device automatically generates first source code files for the API based upon the API description and stores the first source code files in a software development platform. The server computing device receives, from a remote computing device, one or more updates to the first source code files and applies the updates to the first source code files in the software development platform. The server computing device configures one or more resources in the distributed computing environment to be used for deployment of the API in the distributed computing environment. The server computing device generates an API build based upon the updated source code files in the software development platform. The server computing device deploys the API build to the distributed computing environment using the configured resources. The server computing device publishes the deployed API build in the distributed computing environment to enable external computing resources to access the deployed API build.

The invention, in another aspect, features a computerized method of automatic configuration and deployment of application programming interface (API) functionality in a distributed computing environment. A server computing device creates an API description for an API to be deployed to the distributed computing environment, the description defining one or more functional features of the API. The server computing device validates the API description based upon one or more technical constraints and one or more compliance constraints. The server computing device automatically generates first source code files for the API based upon the API description and stores the first source code files in a software development platform. The server computing device receives, from a remote computing device, one or more updates to the first source code files and applies the updates to the first source code files in the software development platform. The server computing device configures one or more resources in the distributed computing environment to be used for deployment of the API in the distributed computing environment. The server computing device generates an API build based upon the updated source code files in the software development platform. The server computing device deploys the API build to the distributed computing environment using the configured resources. The server computing device publishes the deployed API build in the distributed computing environment to enable external computing resources to access the deployed API build.

Any of the above aspects can include one or more of the following features. In some embodiments, the distributed computing environment comprises a cloud computing environment. In some embodiments, the one or more compliance constraints comprise linting rules for the API. In some embodiments, the first source code files comprise an API template, an API stub, one or more environment configuration files, one or more deployment pipeline files, and one or more publication files.

In some embodiments, configuring one or more resources in the distributed computing environment comprises enabling a URL address for the API in a traffic routing resource in the distributed computing environment, deploying a load balancer resource associated with the API in the distributed computing environment, and allocating a virtual computing resource for hosting the API in in the distributed computing environment. In some embodiments, the API build is generated by executing a first job associated with the API in the software development platform. In some embodiments, the API build is deployed to the distributed computing environment by executing a second job associated with the API in the software development platform. In some embodiments, publishing the deployed API build comprises exposing the API to traffic from the external computing resources via the URL address for the API.

In some embodiments, the server computing device deploys the updated source code files for the API to a testing environment and validates the one or more functional features of the API in the testing environment before configuring the one or more resources in the distributed computing environment. In some embodiments, the server computing device validates the one or more functional features of the API in the distributed computing environment after the deployed API build is published in the distributed computing environment.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for automatic configuration and deployment of application programming interface (API) functionality in a distributed computing environment.

FIG. 2 is a flow diagram of a computerized method of automatic configuration and deployment of API functionality in a distributed computing environment.

FIG. 3 is a block diagram of a resource cluster configured in a distributed computing environment by the resource configuration module of the server computing device.

FIG. 4 is a detailed workflow ladder diagram of a computerized method of automatic configuration and deployment of API functionality in a distributed computing environment.

FIG. 5 is a diagram of an exemplary user interface generated by the UI module to enable a user at a client computing device to initiate an automatic API build and deployment process.

FIG. 6 is a diagram of an exemplary user interface generated by the UI module to enable a user at a client computing device to monitor the status of the automatic API build and deployment process.

FIG. 7 is a diagram of an exemplary user interface generated by the UI module to enable a user at a client computing device to view API code generated by the automatic API build and deployment process.

### DETAILED DESCRIPTION

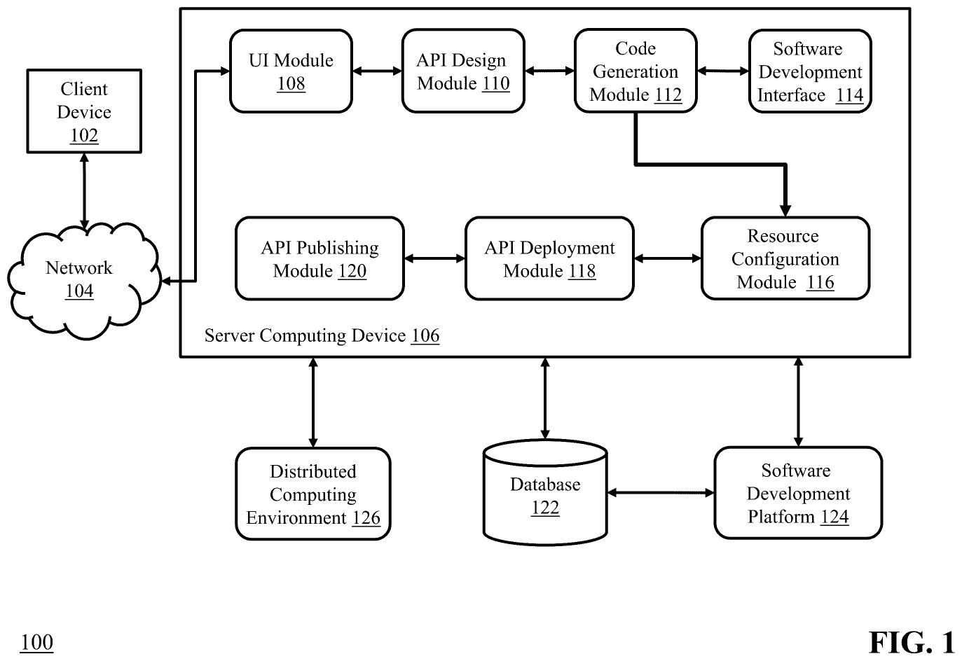

FIG. 1 is a block diagram of system 100 for automatic configuration and deployment of application programming interface (API) functionality in a distributed computing environment. System 100 includes one or more client computing devices (e.g., client computing device 102) that is coupled via communications network 104 to server computing device 106. Server computing device 106 includes user interface (UI) module 108, API design module 110, code generation module 112, software development interface 114, resource configuration module 116, API deployment module 118, and API publishing module 120. Server computing device 106 is coupled to database 122, software development platform 124, and distributed computing environment 126.

Client computing device 102 connects to communications network 104 in order to communicate with server computing device 106 to provide input and receive output relating to the process of automatic configuration and deployment of API functionality in a distributed computing environment as described herein. Client computing device 102 is coupled to a display device (not shown). For example, client computing device 102 can provide a detailed graphical user interface (GUI) via the display device that presents output resulting from the methods and systems described herein, where the GUI is utilized by an operator to review data associated with the process of automatic configuration and deployment of API functionality in a distributed computing environment.

Exemplary client devices 102 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts a single client device 102, it should be appreciated that system 100 can include any number of client devices.

Communication network 104 enables the other components of system 100 to communicate with each other in order to perform the process of automatic configuration and deployment of API functionality in a distributed computing environment as described herein. Network 104 may be a local network, such as a LAN, or a wide area network, such as the Internet and/or a cellular network. In some embodiments, network 104 is comprised of several discrete networks and/or sub-networks (e.g., cellular to Internet) that enable the components of system 100 to communicate with each other.

Server computing device 106 is a combination of hardware, including one or more special-purpose processors and one or more physical memory modules, and specialized software modules-such as UI module 108, API design module 110, code generation module 112, software development interface 114, resource configuration module 116, API deployment module 118, and API publishing module 120—that execute on one or more of the processor(s) of server computing device 106, to receive data from other components of system 100, transmit data to other components of system 100, and perform functions for automatic configuration and deployment of API functionality in a distributed computing environment as described herein. In some embodiments, modules 108 through 120 are specialized sets of computer software instructions programmed onto a dedicated processor (or processors) in server computing device 106 and can include specifically-designated memory locations and/or registers for executing the specialized computer software instructions. Further explanation of the specific processing performed by modules 108 through 120 will be provided below.

Database 122 comprises transient and/or persistent memory for data storage, that is used in conjunction with the process of automatic configuration and deployment of API functionality in a distributed computing environment as described herein. In some embodiments, database 122 stores certain data elements relating to the features and framework of each API built and deployed system 100. For example, database 122 can store API model objects as data structures that represent API specification details associated with a particular API-such as API name, API version, token(s), framework details, links to application lifecycle management (ALM) tools, API endpoints, API requests, API responses, API consumers, related backend systems such as database procedures and HTTP endpoints, and the like. Modules 108 to 120 of server computing device 106 can access database 122 to retrieve and store data elements as part of the process for building, configuring, and deploying APIs in distributed computing environment 126. The data in database 122 can be also used by UI module 108 for the generation of one or more user interface screens that are presented to a user via, e.g., client device 102, as will be explained in greater detail below.

Software development platform 124 is a computing device, or set of computing devices, that Generally, software development platform 124 comprises source code management (SCM) system(s) configured to store and manage software application code files, artifacts, libraries, version control mechanisms, function calls, configuration files, metadata, and other elements that make up one or more application programming interfaces. In some embodiments, software development platform 124 is hosted on one or more remote computing devices (e.g., cloud-based architecture) that are accessible to server computing device 106. Exemplary software development platforms 124 include Git™ (available at git-scm.com), Mercurial™ (available from mercurial-scm.org), and Jenkins™ (available from jenkins.io).

Distributed computing environment 126 is a combination of hardware, including one or more computing devices comprised of special-purpose processors and one or more physical memory modules, and specialized software executed by processor(s) of computing devices in distributed computing environment 126, to receive API requests from remote computing devices, process the API requests, and provide responses to the API requests. In some embodiments, distributed computing environment is configured as a cloud computing platform and/or in a software-as-a-service (SaaS) architecture. Exemplary computing platforms that can be used for distributed computing environment 126 include, but are not limited to, Amazon® Web Services (AWS); IBM® Cloud™; and Microsoft® Azure™. It should be appreciated that other types of computing resource distribution and configuration in a distributed computing environment can be used within the scope of the technology described herein.

Generally, an API is a collection of functions, procedures, definitions, and protocols that enable integration of application software. API requests and responses can be exchanged between remote computing devices and distributed computing environment 126 using any of a number of different architectures, including but not limited to: Representational State Transfer (REST) or Simple Object Access Protocol (SOAP). In one implementation of the REST architecture that can be used in system 100, for example, resources are accessed using Uniform Resource Identifiers (URIs) and requests/responses are exchanged using Hypertext Transfer Protocol (HTTP).

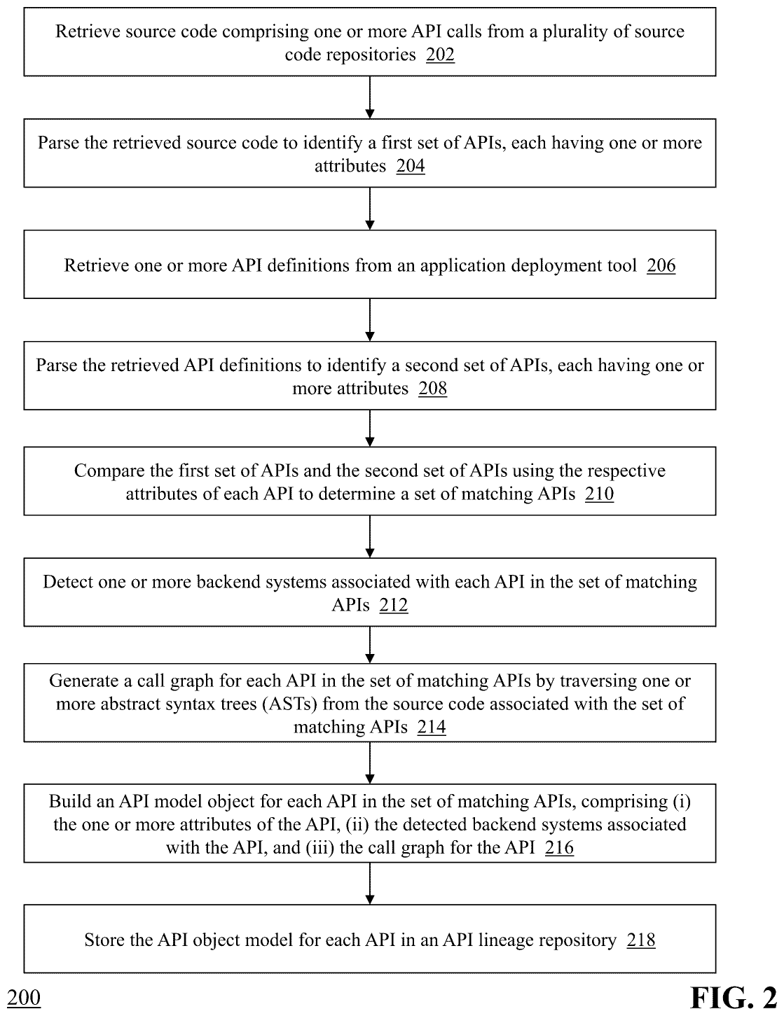

FIG. 2 is a flow diagram of a computerized method 200 of automatic configuration and deployment of API functionality in a distributed computing environment, using system 100 of FIG. 1. In some embodiments, server computing device 106 is accessible by software installed at client computing device 102 to enable client computing device 102 to connect to UI module 108 via an HTTP session in a browser, provide commands for the generation of one or more API specifications, and receive and view UI screens associated with the status and progress of API development and deployment. For example, upon logging into server computing device 106, a user at client computing device 102 can interact with API design module 110 to create (step 202) a definition for a new API to be deployed to distributed computing environment 126. In some embodiments, API design module 110 is implemented in server computing device 106 using the Swagger™ Editor open-source toolset (swagger.io) available from OpenAPI. Using API design module 110, the user at client device 102 can provide input to create and configure the API definition for the new API. In one example, the user can use an editor provided in API design module 110 to write the API definition in YAML or JSON format and/or upload an already-created YAML/JSON file to API design module 110. Once the API definition is created, the user can instruct API design module 110 to store the API definition in, e.g., database 122.

API design module 110 validates (step 204) the newly-created API definition based upon one or more technical constraints and one or more compliance constraints. As can be appreciated, before deploying an API that is based upon the API definition in distributed computing environment 126, it is important to validate the structure and functionality of the API to ensure that the API complies with both technical constraints of environment 126 as well as any compliance constraints imposed by an administrator or enterprise that manages the API in environment 126. In some embodiments, API design module 110 validates the API definition to confirm the proper configuration of certain technical aspects-such as integrity of data requests and/or responses, validation of API metadata, proper error handling, authentication, and security. For example, API design module 110 can parse the YAML/JSON code that comprises the API definition using one or more technical constraint rules to ensure that the form, structure, and syntax of the API definition is correct and complete.

Regarding compliance constraints, an organization may have specific API style guidelines, standards, and practices to which every API must adhere before it is released to a production environment. In some embodiments, these compliance constraints take the form of linting rules that are created by the organization for evaluation of APIs prior to release. In some embodiments, API design module 110 can validate the newly-created API definition for compliance with the linting rules using, e.g., an open source linting validation tool such as Spectral™. When API design module 110 determines that an API definition cannot be validated according to the compliance constraints, module 110 can transmit a notification to the user at client computing device 102 that explains the failure of validation and instructs the user to modify the API definition to bring it into compliance.

In some embodiments, prior to or after completion of the above-referenced validation steps, API design module 110 can transmit the API definition to a client computing device associated with an API validation team. This team can manually review the API definition to identify any issues or errors, provide comments to the API definition, and/or approve the API definition as valid for deployment as an API in the production environment.

Once the API definition is generated and validated as described above, code generation module 112 of server computing device 112 receives the API definition and automatically generates (step 206) first source code files for the API based upon the API definition. In some embodiments, code generation module 112 is implemented in server computing device 106 using the Swagger™ CodeGen open-source toolset (swagger.io) available from OpenAPI. For example, code generation module 112 can receive the API definition and automatically generate, e.g., one or more API client libraries, API templates, server stubs, classes, models, environment configuration files, deployment pipeline files, publication files, user documentation, and other packages that are used as a framework to deploy the API in distributed computing environment 126. Code generation module 112 can store the generated source code files in, e.g., database 122 for access by software development platform 124 as described below.

Software development interface 114 then connects one or more remote computing devices (e.g., client computing device 102) to software development platform 124 for development of the API using the generated source code files. During this phase, software development interface 114 receives (step 208) one or more updates to the first source code files and applies the updates to the first source code files in software development platform 114. For example, the user at client computing device 102 can be a developer that is tasked with programming the underlying logic and functionality for the API. The user can complete development of the API definition by, e.g., adding custom code for functions and features of the API-including modification of the API source code files generated by code generation module 112. In some embodiments, software development interface 114 coordinates aspects of the code development process with software development platform 124, such as version control, file check in/check out, authoring, integrity checks, and so forth. In some embodiments, once the API definition is complete, software development interface 114 can build the API from the definition and deploy the API in a testing environment (not shown) for the purposes of, e.g., functional validation testing.

Once development of the API definition has been completed (and optionally validated in a test environment), resource configuration module 116 configures (step 210) one or more resources in distributed computing environment 126 to be used for deployment of the API. In some embodiments, resource configuration module 116 connects to environment 126 and executes a script to configure certain resources that will enable deployment and operation of the API. In some embodiments, resource configuration module 116 creates a cluster of services (including one or more instances of the API) in distributed computing environment 126 that is then accessed by external computing devices via HTTP/HTTPS routes. In one example, resource configuration module 116 is part of a containerized application deployment and management platform, such as Kubernetes™ (kubernetes.io). In this example, resource configuration module 116 can use the Ingress object/controller and/or Gateway API for Ingress model in Kubernetes to configure and manage the resources in environment 126

Module 116 can enable a URL address for the API in a traffic routing resource in distributed computing environment 126. For example, the traffic routing resource can be configured to receive incoming API requests and route the incoming requests to one or more destination APIs using the URL address. In some embodiments, the traffic routine resource is an API gateway that acts as an entry point for remote computing devices to access APIs provided by distributed computing environment 126. Generally, the traffic routing resource receives API requests from remote computing devices, processes the API requests (e.g., according to defined policies) to direct the requests to the appropriate APIs using the configured URL, and returns API responses to remote computing devices. In some embodiments, the traffic routing resource redirects the remote computing device(s) to an API endpoint that is assigned the URL address for direct exchange of API requests/responses.

Resource configuration module 116 can deploy a load balancer resource associated with the API in distributed computing environment 126. For example, module 116 can instantiate a resource that manages the flow of API requests across one or more clusters. In some embodiments, multiple instances of a particular API are deployed to distributed computing environment 126 and the load balancer resource can handle appropriate routing of API traffic to the instances to ensure optimal performance, low latency, and high availability of the API instances.

Resource configuration module 116 can allocate a virtual computing resource for hosting the API in distributed computing environment 126. In some embodiments, the virtual computing resource comprises one or more services and/or containers (e.g., one or more Kubernetes pods) in environment 126 to host and execute the API functionality and enable communications with backend resources (e.g., databases, other services) to handle and respond to incoming API requests.

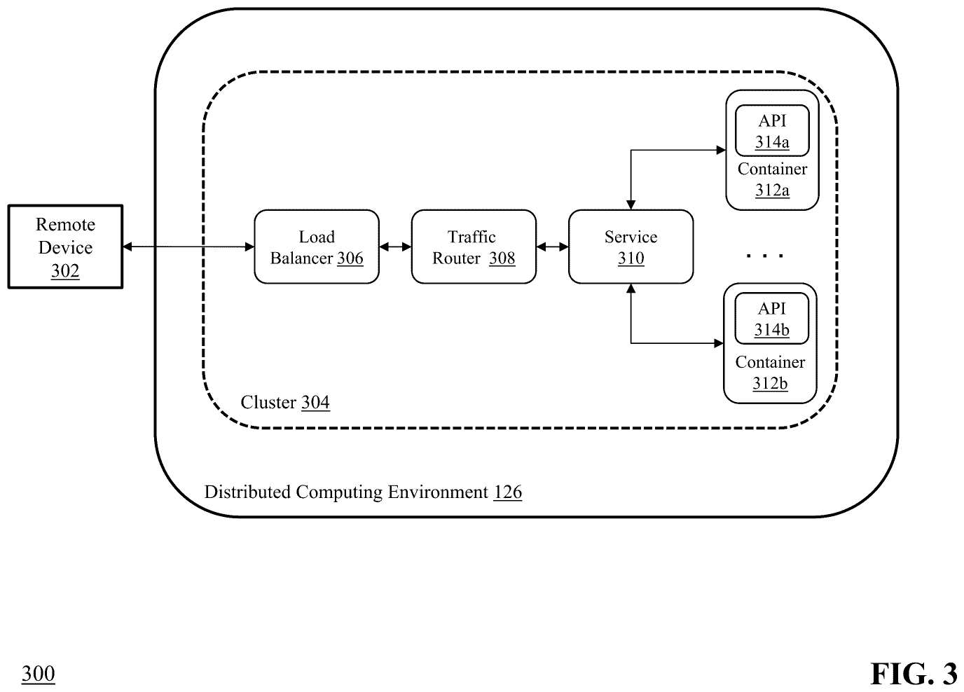

FIG. 3 is a block diagram of a resource cluster 300 configured by resource configuration module 116 in distributed computing environment 126. As shown in FIG. 3, remote computing device 302 (e.g., an external computing device that transmits API requests for servicing by distributed computing environment 126) connects to cluster 304 in environment 126 and transmits one or more API requests to cluster 304, where the requests are received by load balancer 306. Load balancer 306 determines which container 312a, 312b should receive the incoming API requests. Traffic router 308 identifies an endpoint URL associated with the determined container 312a, 312b and/or with service 310, and transmits the API requests to service 310 for distribution of the API requests to container 312a, 312b—each of which hosts an instance of API 314a, 314b.

Once resource configuration module 116 has configured the necessary resources in distributed computing environment 126, API deployment module 118 generates (212) an API build based upon the updated source code files in software development platform 124. As described previously, developers modify the automatically-generated source code files for the newly-created API definition and store the changed files in platform 124. When development is completed, API deployment module 118 retrieves the updated files from platform 124 and/or database 122 and generates the API build by executing a create application job in software development platform 124. In one example, the create application job is a Jenkins job that compiles the API build using the corresponding source code files. In some embodiments, the create application job is part of a deployment pipeline used by API deployment module 118 to build and deploy APIs in environment 126.

API deployment module 118 then deploys (step 214) the generated API build in distributed computing environment 126. As mentioned previously, module 118 can deploy the API build into one or more containers in environment 126, where the API build is executed and hosted to receive API requests from external requestor computing devices. In some embodiments, module 118 executes a deployment job (e.g., a Jenkins job) associated with the API build in software development platform 124 to deploy the API build to environment 126. Also, once the API build is deployed to distributed computing environment 126, API deployment module 118 can optionally perform one or more validation tests on the API to, e.g., confirm that deployment was successful, the API is operating normally, and the API is ready to receive live production API requests.

After deployment of the newly-created API to distributed computing environment 126, API publication module 120 of server computing device 106 publishes (step 216) the deployed API build in environment 126 to enable external computing resources to access the deployed API build. In some embodiments, module 120 is based upon the Stratum platform (github.com/doc-vu/Stratum) for enabling automatic publication, scaling, and performance monitoring for the API. To publish the deployed API build, module 120 can instruct one or more resources in distributed computing environment 126 to expose the API to traffic from external computing resources via the previously-configured URL address for the API. In some embodiments, module 120 also publishes the API in, e.g., a digital exchange so that other resources—including external computing resources—are aware of the API's availability and how to access it.

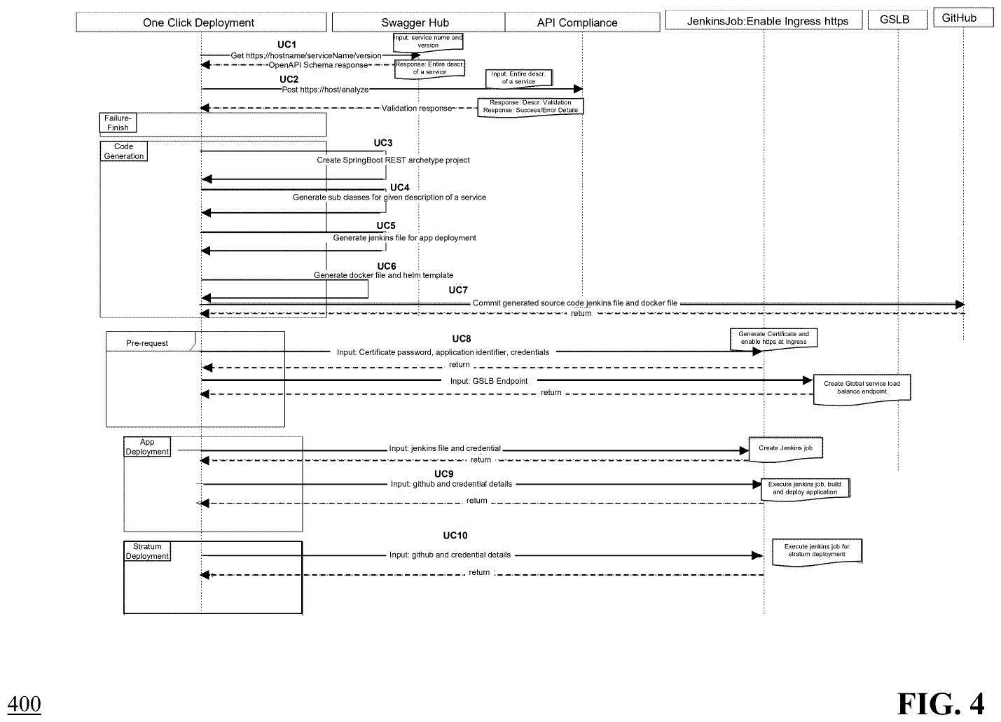

FIG. 4 is a detailed workflow ladder diagram of a computerized method 400 of automatic configuration and deployment of API functionality in a distributed computing environment, using system 100 of FIG. 1. As shown in FIG. 4, method 400 comprises a plurality of steps (UC1 to UC10) that generally map to the step set forth in FIG. 2 as described above. In step UC1, system 100 generates the API description for a new API to be deployed to distributed computing environment 126-a service name and version is provided to Swagger Hub as input, which returns the entire description for the corresponding API service (as part of an OpenAPI schema response). In step UC2, the API description is transmitted to an API compliance module that validates the API description and returns a validation response that includes either a success message (when the API description is determined to be compliant) or an error details message (when the API description is determined to be non-compliant). In situations where the API description is non-compliant, the method concludes with a failure condition. Otherwise, the method proceeds to step UC3.

Steps UC3 to UC7 comprise the code generation phase, where code generation module 114 of server computing device 106 generates the source code files that are used to build and deploy the API based upon the corresponding API description. In step UC3, a SpringBoot REST Maven archetype project is created (i.e., an API template that is used as a foundation for the API code generation). In step UC4, one or more subclasses are generated for the API based upon the corresponding API description. In step UC5, a jenkins file is generated for deployment of the API (e.g., to environment 126 and/or to a testing environment). In step UC6, a docker file and helm template for the API is generated. And, in step UC7, the generated source code files (e.g., jenkins file, docker file, etc.) are committed to software development platform 124.

Step UC8 comprises the pre-request phase, where resource configuration module 116 configures the resources in distributed computing environment 126 that will be used to execute and host the API. In step UC8, resource configuration module 116 provides the certificate password, application identifier, and credentials as input to the jenkins job that generates a certificate and enables https at Ingress. Then, resource configuration module 116 provides a request for a global service load balance (GSLB) endpoint to environment 126, which creates the GSLB endpoint for hosting the API.

Step UC9 comprises the app deployment phase, where API deployment module 118 builds and deploys the API to environment 126. In step UC9, module 118 creates a jenkins job for building and deploying the API, using the jenkins file and credentials as input. Then, module 118 executes the created jenkins job (providing the github repository address for the source code files and the credential details as input) to build and deploy the API to environment 126 as described above.

Step UC10 comprises the publication phase, where API publication module 120 publishes the API in the distributed computing environment to enable external computing resources to access the deployed API build. In step UC10, module 120 provides the github repository address and credential details as input to a jenkins job that executes and publishes the API in Stratum.

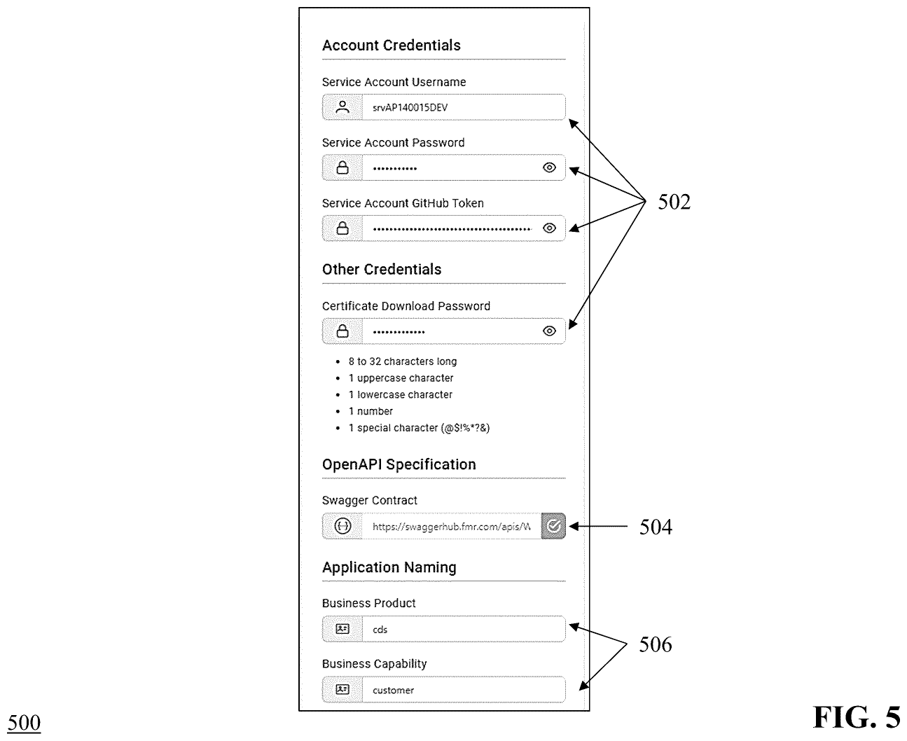

FIG. 5 is a diagram of an exemplary user interface generated by the UI module to enable a user at a client computing device 102 to initiate an automatic API build and deployment process to distributed computing environment 126, as performed by server computing device 106. As shown in FIG. 5, user interface 500 includes form fields 502 for the user to provide relevant service account credentials and other data (e.g., GitHub token, certificate download password) to enable server computing device 106 to access necessary resources and repositories to complete the API build and deployment process. User interface 500 also includes form field 504 to enable the user to provide an address (e.g., URL) for retrieval of the API specification as well as fields 506 to enable the user to name the API.

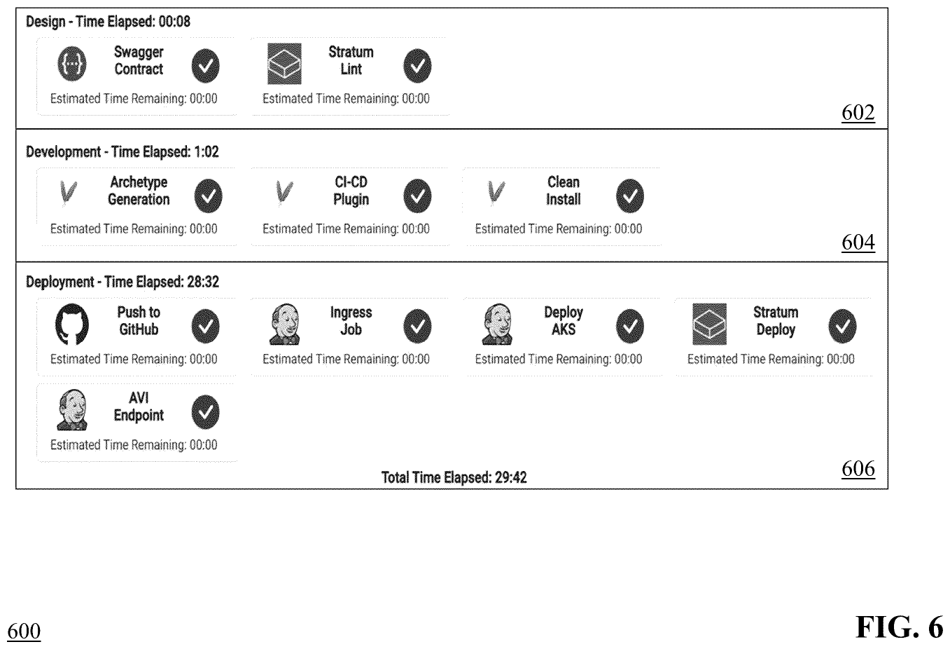

FIG. 6 is a diagram of an exemplary user interface 600 generated by UI module 108 to enable a user at client computing device 102 to monitor the status of the automatic API build and deployment process to distributed computing environment 126, as performed by server computing device 106. As shown in FIG. 6, user interface 600 is divided into three sections: Design 602, Development 604, and Deployment 606. Each section displays the total time elapsed for the process steps in the corresponding section, as well as a tile for each different step that shows the estimated time remaining and the status (e.g., a checkmark indicates successful completion of the step, an ‘X’ would indicate failure of a step). User interface 600 also shows the total time elapsed for building and deployment of the API, at the bottom of the screen. This user interface 600 provides developers and other personnel with a simple, easy-to-understand way to track the progress of automatic API deployment into distributed computing environment 126. The user can see an expected completion time, as well as pinpoint deployment tasks that either have completed successfully or have encountered errors. As a result, the user can quickly diagnose potential issues for remediation and re-start the deployment process with minimal delay.

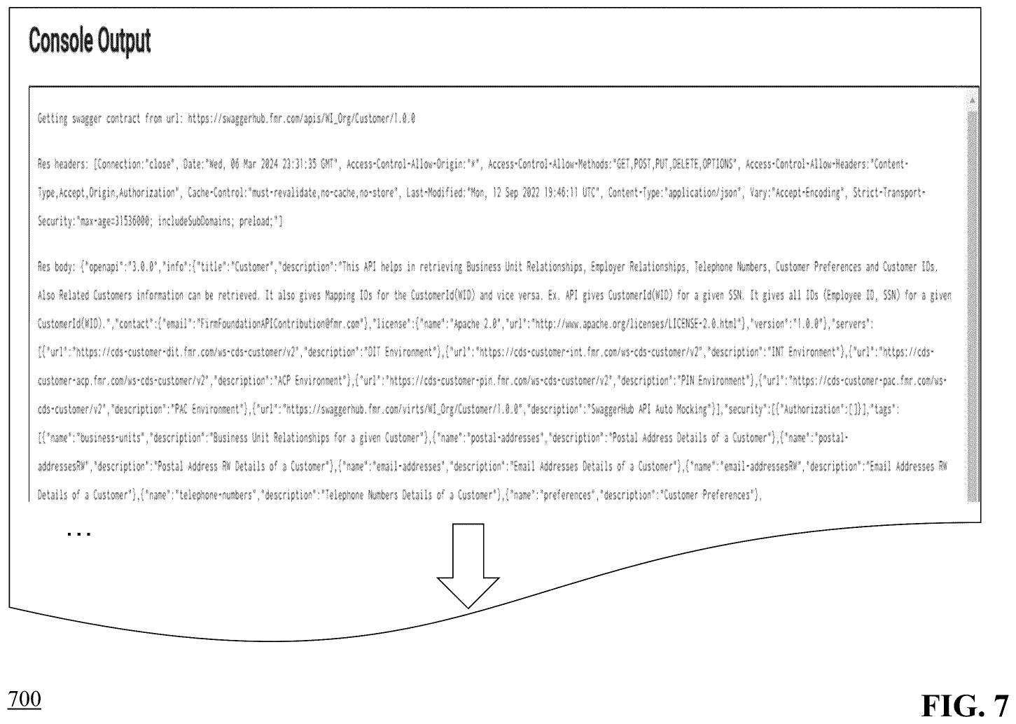

FIG. 7 is a diagram of an exemplary user interface 700 generated by the UI module 108 to enable a user at a client computing device 102 to view API code generated by the automatic API build and deployment process to distributed computing environment 126, as performed by server computing device 106. As shown in FIG. 7, user interface 700 includes a console output window 702 that displays the API code generated by modules of server computing device 106 as described herein.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—allowing access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for automatic configuration and deployment of application programming interface (API) functionality in a distributed computing environment, the system comprising a server computing device having a memory for storing computer-executable instructions and a processor that executes the computer executable instructions to:
create an API description for an API to be deployed to the distributed computing environment, the description defining one or more functional features of the API;
validate the API description based upon one or more technical constraints and one or more compliance constraints;
automatically generate first source code files for the API based upon the API description and store the first source code files in a software development platform;
receive, from a remote computing device, one or more updates to the first source code files and apply the updates to the first source code files in the software development platform;
configure one or more resources in the distributed computing environment to be used for deployment of the API in the distributed computing environment;
generate an API build based upon the updated source code files in the software development platform;
deploy the API build to the distributed computing environment using the configured resources; and
publish the deployed API build in the distributed computing environment to enable external computing resources to access the deployed API build.

2. The system of claim 1, wherein the distributed computing environment comprises a cloud computing environment.

3. The system of claim 2, wherein the one or more compliance constraints comprise linting rules for the API.

4. The system of claim 3, wherein the first source code files comprise an API template, an API stub, one or more environment configuration files, one or more deployment pipeline files, and one or more publication files.

5. The system of claim 1, wherein configuring one or more resources in the distributed computing environment comprises:
enabling a URL address for the API in a traffic routing resource in the distributed computing environment;
deploying a load balancer resource associated with the API in the distributed computing environment; and
allocating a virtual computing resource for hosting the API in in the distributed computing environment.

6. The system of claim 5, wherein the API build is generated by executing a first job associated with the API in the software development platform.

7. The system of claim 6, wherein the API build is deployed to the distributed computing environment by executing a second job associated with the API in the software development platform.

8. The system of claim 7, wherein publishing the deployed API build comprises exposing the API to traffic from the external computing resources via the URL address for the API.

9. The system of claim 1, wherein the server computing device deploys the updated source code files for the API to a testing environment and validates the one or more functional features of the API in the testing environment before configuring the one or more resources in the distributed computing environment.

10. The system of claim 1, wherein the server computing device validates the one or more functional features of the API in the distributed computing environment after the deployed API build is published in the distributed computing environment.

11. A computerized method of automatic configuration and deployment of application programming interface (API) functionality in a distributed computing environment, the method comprising:
creating, by a server computing device, an API description for an API to be deployed to the distributed computing environment, the description defining one or more functional features of the API;
validating, by the server computing device, the API description based upon one or more technical constraints and one or more compliance constraints;
automatically generating, by the server computing device, first source code files for the API based upon the API description and storing the first source code files in a software development platform;
receiving, by the server computing device from a remote computing device, one or more updates to the first source code files and applying the updates to first source code files in the software development platform;
configuring, by the server computing device, one or more resources in the distributed computing environment to be used for deployment of the API in the distributed computing environment;
generating, by the server computing device, an API build based upon the updated corpus of source code in the software development platform;
deploying, by the server computing device, the API build to the distributed computing environment using the configured resources; and
publishing, by the server computing device, the deployed API build in the distributed computing environment to enable external computing resources to access the deployed API build.

12. The method of claim 11, wherein the distributed computing environment comprises a cloud computing environment.

13. The method of claim 12, wherein the one or more compliance constraints comprise linting rules for the API.

14. The method of claim 13, wherein the first source code files comprise an API template, an API stub, one or more environment configuration files, one or more deployment pipeline files, and one or more publication files.

15. The method of claim 11, wherein configuring one or more resources in the distributed computing environment comprises:
enabling a URL address for the API in a traffic routing resource in the distributed computing environment;
deploying a load balancer resource associated with the API in the distributed computing environment; and
allocating a virtual computing resource for hosting the API in in the distributed computing environment.

16. The method of claim 15, wherein the API build is generated by executing a first job associated with the API in the software development platform.

17. The method of claim 16, wherein the API build is deployed to the distributed computing environment by executing a second job associated with the API in the software development platform.

18. The method of claim 17, wherein publishing the deployed API build comprises exposing the API to traffic from the external computing resources via the URL address for the API.

19. The method of claim 11, wherein the server computing device deploys the updated source code files for the API to a testing environment and validates the one or more functional features of the API in the testing environment before configuring the one or more resources in the distributed computing environment.

20. The method of claim 11, wherein the server computing device validates the one or more functional features of the API in the distributed computing environment after the deployed API build is published in the distributed computing environment.
